(19) United States
(12) Patent Application Publication
(10) Pub. No.: US 2024/0354802 A1
(43) Pub. Date: Oct. 24, 2024

(54) SYSTEM AND METHOD FOR ON-DEMAND CARE SERVICE

(71) Applicant: Kiyeon NAM, Bayside, NY (US)

(72) Inventor: Kiyeon NAM, Bayside, NY (US)

(21) Appl. No.: 18/759,832

(22) Filed: Jun. 29, 2024

Related U.S. Application Data
(63) Continuation of application No. PCT/US2022/054408, filed on Dec. 31, 2022.
(60) Provisional application No. 63/295,780, filed on Dec. 31, 2021.

(51) Int. Cl. G06Q 30/0234

(52) U.S. Cl. CPC G06Q 30/0234

(57) ABSTRACT

A method of operating a service network that manages requesting and providing on-demand care services and rewarding for the provided services is provided. The method comprises receiving, from a care giver or a care receiver, a signal for requesting a service; obtaining location information of the care receiver; providing a participant with the location information and information associated with the service; receiving, from the participant, a signal indicating completion of the service; transmitting, to the care giver, a signal indicating that the service has been completed; receiving, from the care giver, approval for reward; and rewarding the participant with a predetermined amount of digital currency.

### CROSS-REFERENCE TO RELATED APPLICATION(S)

This application is a Continuation of International Application No. PCT/US2022/054408filed Dec. 31, 2022, which claims priority from U.S. Provisional Application No. 63/295,780 filed Dec. 31, 2021. The aforementioned applications are incorporated herein by reference in their entireties.

### TECHNICAL FIELD

The present disclosure relates to systems and methods for providing on-demand care service, and more particularly, to those systems and methods of on-demand care service with digital currency payment.

According to the Federal Bureau of Investigation (FBI), 337,000 children went missing in 2021. According to the CDC, more than 75 million people have autism spectrum disorder (ASD), and more than 50 million people have dementia worldwide. About half of those vulnerable populations are prone to wander into dangerous, sometimes deadly, situations. Every 90 seconds, a child is reported to be missing in the United States. There are hundreds of missing people on a daily basis, and not all of them are even reported. Most people who wander are found, but some never come back. Hence, for millions of families with ASD or Alzheimer patients, the top priorities in their daily lives are keeping those loved ones safe and protected.

### SUMMARY

The present disclosure provides systems and methods for providing on-demand care and rewarding with digital currency for the provided care. The on-demand care service according to the present disclosure may facilitate more active participation in volunteer services by users.

In an aspect of the present disclosure, a method of operating a service network may include receiving, from a care giver or a care receiver, a signal for requesting a service; obtaining location information of the care receiver; providing a participant with the location information and information associated with the service; receiving, from the participant, a signal indicating completion of the service; transmitting, to the care giver, a signal indicating that the service has been completed; receiving, from the care giver, approval for reward; and rewarding the participant with a predetermined amount of digital currency.

In some embodiments, the location information of the care receiver may be obtained by the participant who is within a connectivity range from the care receiver. In some other embodiments, the location information of the care receiver may be obtained by another participant who is within a connectivity range from the care receiver, and may be transmitted from the another participant to the service network. In some embodiments, the location information of the care receiver may be obtained using Bluetooth®, global positioning satellite (GPS), gateway scanners, cell towers, satellites, or the like.

In some embodiments, the care giver may be provided with proof of the completion of the service.

In a related aspect of the present disclosure, a method of requesting on-demand care services and rewarding for the services may include detecting an event that a smart tag of a care receiver is out of a connectivity range from a device of a care giver; requesting, by the care giver or the care receiver, a service to a service network; and in response to receiving a signal indicating that a participant has completed the requested service, approving, by the care giver, a reward to the participant with a predetermined amount of digital currency. The predetermined amount of digital currency may be determined based on different levels of participation.

In another related aspect of the present disclosure, a method of providing on-demand care services and receiving reward for the services may include obtaining location information of a care receiver; receiving, from a service network, a request for a service along with information associated with the service; transmitting, to the service network, a signal indicating completion of the service; and receiving a reward in digital currency.

In some embodiments, the location information of the care receiver may be obtained by detecting a smart device or a smart tag of the care receiver being within a connectivity range therefrom. In some other embodiments, the location information of the care receiver may be obtained from the service network, wherein the location information is provided by another participant who is within a connectivity range from a smart tag of the care receiver.

### BRIEF DESCRIPTION OF THE DRAWINGS

A brief description of each drawing is provided to more sufficiently understand drawings used in the detailed description of the present disclosure.

FIG. 1A shows exemplary embodiments of a smart device or a smart tag according to the present disclosure;

FIG. 1B shows collection of exemplary garments that integrate the smart tag according to the present disclosure;

FIG. 2 depicts a smart apparel being linked to a care giver's smart device according to the present disclosure;

FIG. 3 shows an example of providing care via a voluntary participant according to an exemplary embodiment of the present disclosure;

FIG. 4 shows an example of providing care via a voluntary participant according to another exemplary embodiment of the present disclosure;

FIG. 5 depicts an example where a participant within the connectivity range from a care receiver obtains and relays the location information of the care receiver to a hub;

FIG. 6 shows an architectural diagram of the system for on-demand care service according to an exemplary embodiment of the present disclosure.

It should be understood that the above-referenced drawings are not necessarily to scale, presenting a somewhat simplified representation of various preferred features illustrative of the basic principles of the disclosure. The specific design features of the present disclosure, including, for example, specific dimensions, orientations, locations, and shapes, will be determined in part by the particular intended application and use environment.

### DETAILED DESCRIPTION

Advantages and features of the present disclosure and a method of achieving the same will become apparent with reference to the accompanying drawings and exemplary embodiments described below in detail. However, the present disclosure is not limited to the exemplary embodiments described herein and may be embodied in variations and modifications. The exemplary embodiments are provided merely to allow one of ordinary skill in the art to understand the scope of the present disclosure, which will be defined by the scope of the claims. Accordingly, in some embodiments, well-known operations of a process, well-known structures, and well-known technologies will not be described in detail to avoid obscure understanding of the present disclosure. Throughout the specification, same reference numerals refer to same elements.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

The term “care receiver,” as used herein, refers to a person or an animal or any other thing that is registered to a service-providing network for receiving a service. Herein, the “care receiver” may be interchangeably used for the person (or the animal or the thing) who is in need for the service, and a device (e.g., a smart tag or a smart device) that the person possesses.

The term “care giver,” as used herein, refers to a person or an entity who is responsible for providing primary care for the care receiver. Herein, the “care giver” may be interchangeably used for the person (or the entity) who has the responsibility for the primary care, and a device (e.g., a smart device) that the person possesses.

The term “participant” or “volunteer participant,” as used herein, refers to a person or a robot who agrees to provide a service to the care receiver upon a request from the care giver or the care receiver.

Aspects of the present disclosure provide systems and methods for requesting and providing on-demand care services. In particular, the subject matter of the present disclosure may utilize available participant(s) on the spot to provide on-demand service in solving problems or helping in emergency situations, and the participants/users of such system can provide immediate help and even save lives. Moreover, the present disclosure also provides awarding in digital currency, depending on different types of services provided by a voluntary participant. Accordingly, the systems and methods for requesting and providing on-demand care services according to the present disclosure may facilitate more active participation from voluntary users, arising out of positive motivation to help others among the participants/users, while the participants/users can generate income based on good-faith actions to take care and help people around or within the community.

In addition, since the technology may be implemented with Internet of Things (IOT) and artificial intelligence (AI) technologies, the data transmission may be more narrowly targeted to relevant users while remaining private against uninvolved general public. Therefore, unlike utilizing social media, news, or newsletters, which often overwhelm people and cause unnecessary panic and nervousness about safety and security of the society, the subject matter of the present disclosure will simply focus on helping those in need and solving problems directly in a least intrusive way. An incident would not be escalated to an overly exaggerated problem or widespread news. Further, due to the AI-based technology, the best matching profile to help or provide service to the care receiver may be identified more accurately and rapidly.

Overall, the technology according to the present disclosure may help care givers and care receivers get help quickly, while participants/users may be compensated with monetary value, which will increase the overall sense of safety and trust within the society.

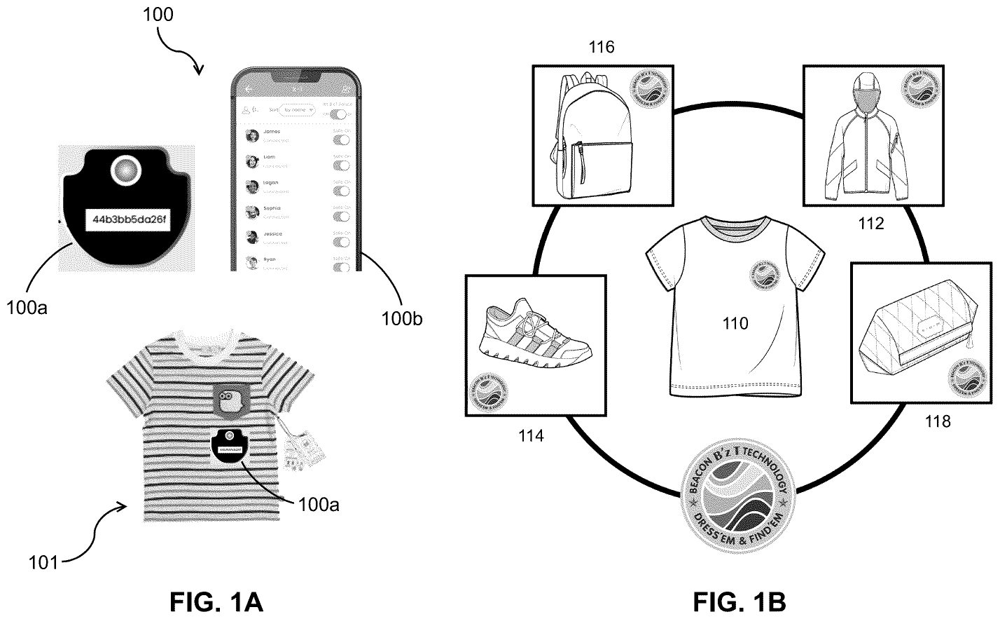

Referring to FIG. 1A, a smart tag (herein also interchangeably referred to as a “smart device” or a “beacon”) may be provided as a stand-alone apparatus 100a or may be implemented in a smart device 100b. In some embodiments, the smart tag 100 (e.g., the stand-alone apparatus 100a) may be implemented in a micro-scale. In some embodiments, the smart tag 100 may be associated with a unique code that may be used to identify the particular smart tag. In some embodiments, the smart tag 100 may be embedded in a smart apparel 101. In some embodiments, the smart tag 100 may include Bluetooth®, GPS, RFID, or any other location tracking capabilities. Some examples of the smart tag 100 embedded in a smart apparel 101 or fabric are described in U.S. Patent Application Publication No. 2019-0082753, which is incorporated herein by reference in its entirety.

By way of example, as shown in FIG. 1B, the smart tag 100 may be incorporated into the fabric of a garment such as a T-shirt 110, as well as other personal garments such as pants, jeans, tops, sweaters, shirts, dresses, and the like. Alternatively, the smart tag 100 may be utilized with an overcoat 112 or other outer garment. Embodiments of the system may similarly be used with footwear 114, bags and luggage 116, and luxury goods 118.

The smart tag with a unique code may collect, transfer, store, and/or broadcast information associated with health, information associated with location, information associated with profile of a care giver, information associated with profile of wearer (i.e., a care receiver), or any combination thereof. By way of example, the information associated with health may include blood pressure, blood sugar level, heart rate, body temperature, or the like.

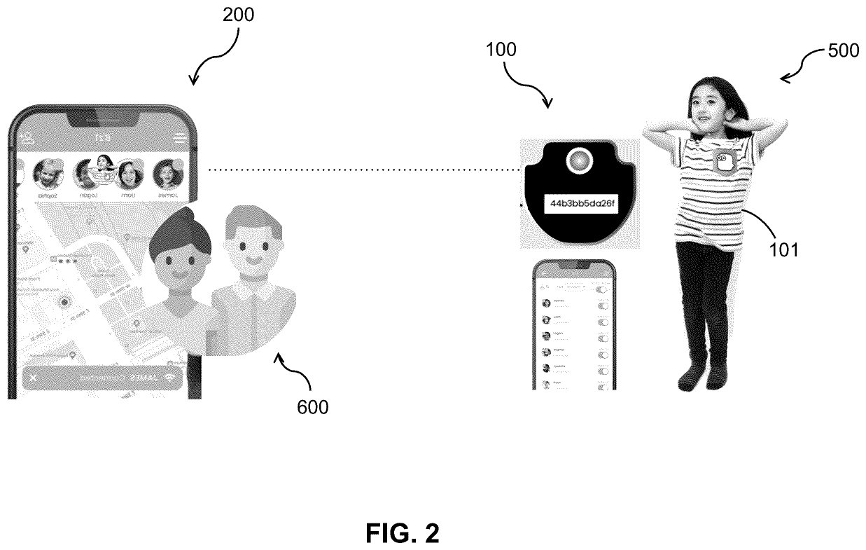

Referring to FIG. 2, the smart tag (or the smart apparel containing the smart tag) may be linked to one or more smart devices. By way of example, the smart apparel 101 may be worn by a care receiver 500 (e.g., a child, an elderly, a pet, etc.), and the smart tag 100 embedded in the smart apparel 101 may be linked to a smart device 200 (e.g., a smart phone) that belongs to a care giver 600 (e.g., a parent, a spouse, a guardian, a son or daughter, etc.). In some embodiments, the smart tag 100 may be implemented as a wearable device, for example, a pendant, a bracelet, a watch, or the like, and may be worn by the care receiver 500. In some embodiments, the smart device 200 of the care giver 600 may be configured to run an application (e.g., an AI-based application) on it, which implements the functionality described in the present disclosure.

In some embodiments, the smart tag 100 may be linked to the smart device 200 based on technologies such as Bluetooth®, GPS, cellular network, satellites, gateways of telecommunication networks, and the like, or via a cloud-based network.

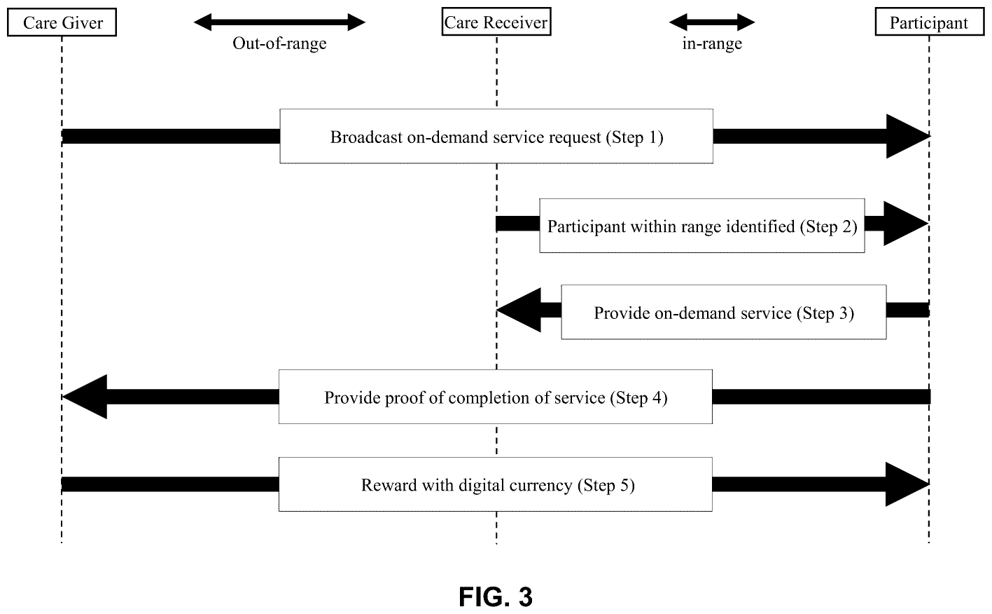

Referring to FIG. 3, in an operation mode according to an exemplary embodiment of the present disclosure, in case when the care receiver (i.e., the smart tag or the smart device that belongs to the care receiver) is out of the connectivity range from the care giver's smart device, the care giver may initiate or broadcast a request for help (Step 1). Alternatively or additionally, the care giver may initiate or broadcast a request for help on-demand for any occasion, such as when the care receiver is located at an unsafe zone, when the care receiver is outside of a comfortable distance, and the like. Such request may be transmitted to a server that provides and manages the on-demand care services, and may be broadcast through a network to which the server is connected. In response to such request, one or more participants pre-registered in the service network who is within the connectivity range from the care receiver may be identified (Step 2). The identified participant, if agrees, may volunteer to provide the requested help/service to the care receiver (Step 3).

Thereafter, the volunteer participant may report the completion of the service to the care giver who requested for help. In some embodiments, proof of the voluntary service may be provided to the care giver (Step 4). In some embodiments, the proof of the voluntary service may be automatically generated and/or transmitted. In return, the care giver may authorize a reward to the volunteer participant with digital currency (Step 5).

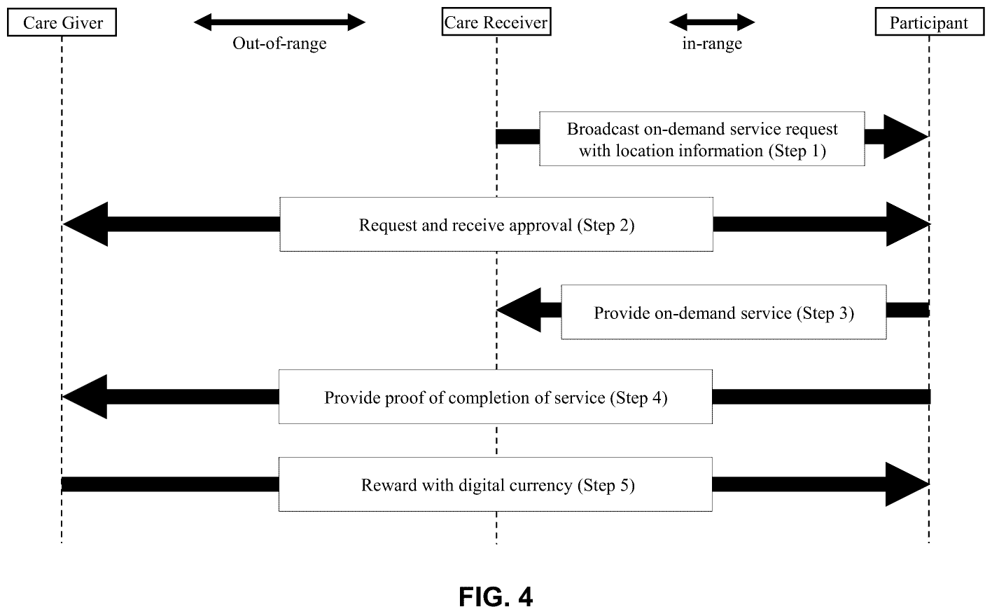

Referring to FIG. 4, in another operation mode according to an exemplary embodiment of the present disclosure, in case when the care receiver is out of the connectivity range from the care giver's smart device, the care receiver may initiate or broadcast a request for help (Step 1). Alternatively or additionally, the care receiver may initiate or broadcast a request for help on-demand for any occasion, such as when the care receiver finds that he or she is at an unfamiliar or unsafe zone, when the care receiver needs help due to weather conditions, and the like. The request may be delivered to one or more participants pre-registered in the service network who is within the connectivity range from the care receiver who requested the service. If no participant is present within the connectivity range from the care receiver, the service request may be continually broadcast until at least one participant is identified within the connectivity range. In some embodiments, the service request may be stopped once at least one participant volunteers to help. In other embodiments, the service request may be continued even after a participant volunteers until either the care receiver or the care giver withdraws the service request.

Once a volunteer participant has been identified, the volunteer participant may send a request for an approval to the care giver and then receive an approval from the care giver (Step 2). Step 2 may be omitted in some embodiments. The volunteer participant may provide the requested help/service to the care receiver (Step 3).

Thereafter, the volunteer participant may report the completion of the service to the care giver who approved the service. In some embodiments, proof of the voluntary service may be provided to the care giver (Step 4). By way of example, a picture may be provided as the proof, or a confirmation by the care receiver may be provided as the proof. In some embodiments, the proof of the voluntary service may be automatically generated and/or transmitted. In return, the care giver may authorize a reward to the volunteer participant with digital currency (Step 5).

In FIGS. 3 and 4, it should be noted that the order of the steps may be variously changed depending on various use cases, and some of the steps may be omitted in some circumstances. For example, in FIG. 4, requesting for and receiving approval from the care giver (Step 2) may be omitted or may be performed after providing the service (Step 3) in life-threatening emergencies.

There may be different tiers of rewards for providing different levels of participation. First, a participant may agree to run the application on its smart device so as to allow the smart device to be utilized as a network node. Herein, this first mode of participation may be referred to as “Type A” participation. In some embodiments, the application may be configured to run on the background, requiring less resources from the smart device. For Type A participation, the participant's smart device may detect the smart tag of the care receiver that is within its connectivity range and relay the location information to the service network. However, the Type A participant may not agree to provide actual service/help. Instead, other participants, even if their smart devices did not receive a signal directly from the care receiver's smart tag, may obtain from the service network the location information of the care receiver who is in need for a service, and may approach the care receiver to provide the requested service/help.

Second, a participant may agree to proactively respond to the service request and provide the requested service to the care receiver. This second mode of participation may be referred to as “Type B” participation. The Type B participant may approach the care receiver based either on the signal directly detected by its own smart device from the care receiver's smart tag or on the location information provided from the service network (i.e., the location information provided by a Type A participant).

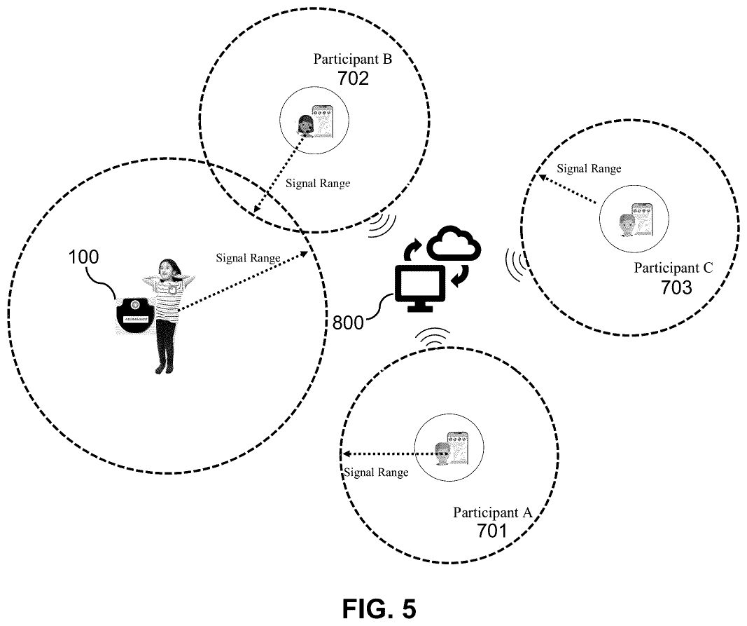

In some embodiments, the application running in the Type A participation mode may purely run on the background and merely relay the location information of the detected smart tags to the service network without notifying its user or requiring any user intervention. In some other embodiments, the application may ask its user whether the user agrees to provide the requested service or not. As shown in FIG. 5, among Participant A 701, Participant B 702, and Participant C 703, the signal range of the smart tag 100 may overlap with the signal range of Participant B 702. If the user (i.e., Participant B 702) agrees to provide the requested service, then the user may be switched to a Type B participant from that point. If the user declines to provide the requested service, then the user remains a Type A participant. In certain embodiments, the user may altogether decline to provide even the Type A participation after detecting a smart tag within the connection range. In such cases, the location information may not be relayed to the service network.

For rewards, the Type A and Type B participations may be awarded with different amounts of digital currency. In particular, Type B participation may be rewarded in a greater amount. The rewards may be diversely structured. By way of example, Type A participation may be rewarded simply based on the application running time, or based on the geographical area covered during a predetermined time period, or based on the number of events of detecting a smart tag and relaying its location information to the service network. Type B participation may be additionally rewarded for the provided services. In some embodiments, the provided services may be divided into different categories, each awarding different amounts of digital currency depending on the level of importance, urgency, difficulty, time-duration, care receiver's satisfaction, or the like.

Examples of the volunteer services may include, but are not limited to, locating a missing child, locating a missing elderly, finding a missing pet (where the pet becomes the care receiver), helping a sick person (e.g., calling first responders or taking the person to a hospital), visiting an elderly's house and checking status, performing medical help (e.g., CPR), saving the care receiver from an emergency (e.g., drowning, fall, or unconsciousness), fixing an automobile problem, fixing home equipment (e.g., furnace or air conditioning).

Referring back to FIG. 5, each of participants' devices may be connected to a hub 800 (e.g., a server). The hub 800 may receive on-demand service requests, broadcast on-demand service requests to the participants within the network, manage and oversee the digital currency transactions, and/or find the best matching participant(s) depending on the location, profile, and/or type of the on-demand care service. The hub 800 may further unify and integrate the service into national organizations, federal or state government agencies, and/or private entities. The hub 800 may also quantify the value of human behaviors (e.g., service actions) as, for example, a “Kindness” index and correlate it to the amount of digital currency.

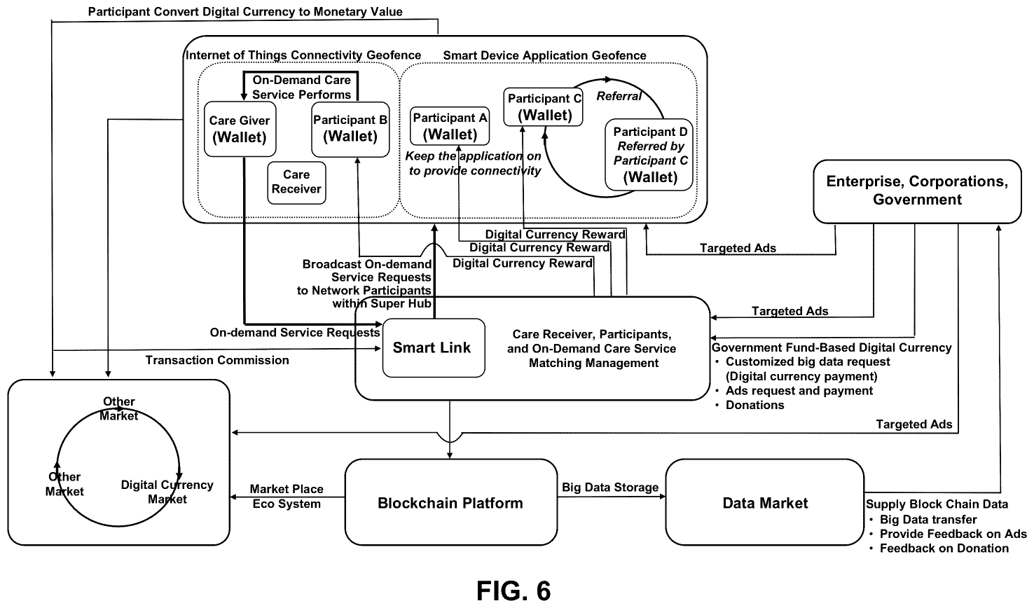

FIG. 6 shows an overall view of the system architecture for on-demand care service according to an exemplary embodiment of the present disclosure. According to embodiments of the present disclosure, various types of services may be provided and managed through the system. In order to provide various types of services, each user may specify his or her specialty or skill set, such that the service providing server (e.g., “Smart Link”) may maintain a database of profiles of the participants and manage the matching between the participants and a particular care receiver for a particular service request. For example, a first participant may designate herself as a doctor, a second participant may designate himself as a firefighter, and a third participant may designate herself as a car mechanic. In such case, if the on-demand service requires medical help, the Smart Link may match the first participant even if the third participant is locationally closer to the care receiver. If the on-demand service involves a broken automobile, the third participant may be matched. The matching may be performed at the Smart Link based on artificial intelligence (AI).

As discussed above, at least some portion of the application providing the services described herein may be implemented with AI technologies. Accordingly, the smart tag and/or the smart apparel may include additional sensors (e.g., bio sensors) to detect an event of emergency and autonomously initiate a service request. By way of example, the bio sensors may include a heart rate monitor, a thermometer, a motion sensor, an audio sensor, a photoplethysmography sensor, a water sensor, or any combination thereof. In some embodiments, the AI-based service may identify a participant among a plurality of participants based on the participant's location, profile, history, or any combination thereof. AI technologies may be utilized to perform transactions of digital assets, digital currencies, crypto currencies, or the like.

As shown in FIG. 6, each participant/user may retain a digital wallet, and the Smart Link may reward participants with digital currency based on the level of participation. Participant B may be rewarded for providing the on-demand service, and Participant A may be rewarded for running the application on his device to provide connectivity and serve as a node. Furthermore, Participant C may be rewarded for referring to another participant, Participant D, to join the service network. The digital currency may be managed based on a blockchain platform, which may interact with digital currency markets and/or conventional currency markets. Accordingly, the system and method for on-demand services according to the present disclosure may handle digital currency and conventional currency more flexibly.

The on-demand service according to the present disclosure may generate economical merits not only for the participants, but also for the service provider. By way of example, referring to FIG. 6, the service provider may utilize the big data collected through providing the services for its economic profits. In turn, the big data may be utilized for corporations and government entities to create, for example, targeted advertisement or data-based policy making. Consequently, the service provider may increase the pool of digital currency that it can mobilize, which would attract more participants to the service network.

In some embodiments, blockchain technology may be utilized to protect personal information of the involved participants, care givers, and care receivers and to secure the transaction of digital currency.

In some embodiments, Type A participation may be provided by something other than a smart device carried by a human. By way of example, Type A participation may be provided by an Internet-of-Things (IOT) device, including but not limited to a car, a drone, a speaker, a bag, or a robot. The smart tag and/or smart apparel itself may provide Type A participation. In some embodiments, the smart tag may be implemented as software instead of a dedicated piece of hardware. In such embodiments, a smart device that belongs to a care receiver may act as a smart tag to communicate with other participant's smart devices. In some embodiments, when two or more participants detect the location information of the care receiver, the location may be more precisely determined by using triangularization.

Hereinabove, although the present disclosure is described by specific matters such as concrete components, and the like, the exemplary embodiments and the drawings are provided merely for assisting in the entire understanding of the present disclosure. Therefore, the present disclosure is not limited to the exemplary embodiments described herein. Various modifications and changes can be made by a person of ordinary skill in the art to which the present disclosure pertains. The spirit of the present disclosure should not be limited to the above-described exemplary embodiments, and the following claims as well as all technical spirits modified equally or equivalently to the claims should be interpreted to fall within the scope and spirit of the disclosure.

What is claimed is:

1. A method of operating a service network, comprising:
receiving, from a care giver or a care receiver, a signal for requesting a service;
obtaining location information of the care receiver;
providing a participant with the location information and information associated with the service;
receiving, from the participant, a signal indicating completion of the service;
transmitting, to the care giver, a signal indicating that the service has been completed;
receiving, from the care giver, approval for reward; and
rewarding the participant with a predetermined amount of digital currency.

2. The method of claim 1, wherein the location information of the care receiver is obtained by the participant who is within a connectivity range from the care receiver.

3. The method of claim 1, wherein the location information of the care receiver is obtained by another participant who is within a connectivity range from the care receiver, and is transmitted from the another participant to the service network.

4. The method of claim 1, further comprising:
providing the care giver with proof of the completion of the service.

5. The method of claim 1, wherein the predetermined amount of digital currency is determined based on different levels of participation.

6. A method comprising:
detecting an event that a smart tag of a care receiver is out of a connectivity range from a device of a care giver;
requesting, by the care giver or the care receiver, a service to a service network; and
in response to receiving a signal indicating that a participant has completed the requested service, approving, by the care giver, a reward to the participant with a predetermined amount of digital currency.

7. The method of claim 6, wherein the predetermined amount of digital currency is determined based on different levels of participation.

8. A method comprising:
obtaining location information of a care receiver;
receiving, from a service network, a request for a service along with information associated with the service;
transmitting, to the service network, a signal indicating completion of the service; and
receiving a reward in digital currency.

9. The method of claim 8, wherein the location information of the care receiver is obtained by detecting a smart tag of the care receiver being within a connectivity range therefrom.

10. The method of claim 8, wherein the location information of the care receiver is obtained from the service network, wherein the location information is provided by another participant who is within a connectivity range from a smart tag of the care receiver.

11. The method of claim 8, wherein an amount of reward is determined based on different levels of participation.
